(19) United States
(12) Patent Application Publication
(10) Pub. No.: US 2014/0312638 A1
(43) Pub. Date: Oct. 23, 2014

(54) SPREADER AND USE THEREOF

(71) Applicants: Ghee Hua Ng, Singapore (SG); Krishna Murari, Singapore (SG); Robert Arthur Mills, Euxton (GB); Cameron Hay, Haberfield (AU)

(72) Inventors: Ghee Hua Ng, Singapore (SG); Krishna Murari, Singapore (SG); Robert Arthur Mills, Euxton (GB); Cameron Hay, Haberfield (AU)

(73) Assignee: NSL ENGINEERING PTE LTD, Singapore (SG)

(21) Appl. No.: 14/130,923

(22) PCT Filed: Jul. 4, 2012
(86) PCT No.: PCT/SG2012/000237

§ 371 Date: Jan. 4, 2014

(30) Foreign Application Priority Data
Jul. 4, 2011 (SG) 201104930-1

(51) Int. Cl. B66C 1/10; B66C 1/42; B65D 88/56; B65G 65/23; B65G 65/38; B65D 90/66; B66C 1/66

(52) U.S. Cl. CPC B66C 1/101; B65D 90/66; B66C 1/104; B66C 1/42; B66C 1/663; B65G 65/23; B65G 65/38; B65D 88/56
USPC 294/86.4; 292/138; 292/57

(57) ABSTRACT

A spreader assembly comprising a spreader having container engagement devices for engaging and disengaging a container; a lid engagement device mounted to the spreader, said lid engagement device having an actuator for positioning a lid engagement frame proximate to a lid of said container, said frame arranged to engage said lid so as to permit the actuator to move said lid relative to the container.

### FIELD OF THE INVENTION

The invention relates to the transportation of shipping containers and other intermodal devices and in particular, the manipulation of said containers and devices by cranes and spreaders. Specifically, the invention relates to purpose-built containers and devices for transporting particulate matter whereby access to the containment through the top surface of said containers.

### BACKGROUND

For the transport of particulate material such as grain, minerals, in particular, iron ore etc, a particular type of container is used having a top surface as the means of filling the container. For transportation, this top surface is sealed by a lid so as to contain and provide security for the material therein.

As preliminary steps in the loading and unloading of the material from said container is to engage the container with a spreader to lift it to the required position, setting it down and disengaging the spreader and then manually removing the lid for subsequent loading and unloading.

It is important for the economic efficiency of the transport of intermodal devices to limit the number of steps in the manipulation of said containers and so having a separate step for the placement and removal of the lid adds to the cost of transportation.

### SUMMARY OF INVENTION

In a first aspect, the invention provides a spreader assembly comprising a spreader having container engagement devices for engaging and disengaging a container; a lid engagement device mounted to the spreader, said lid engagement device having an actuator for positioning a lid engagement frame proximate to a lid of said container, said frame arranged to engage said lid so as to permit the actuator to move said lid relative to the container.

In a second aspect, the invention provides a dual spreader assembly for engaging two containers comprising a head frame; two parallel spreaders mounted to the head frame; each spreader having a first frame through which the spreader is mounted to the head frame and a second frame arranged to engage the respective container, wherein said first and second frames are in rotational engagement such that the second frame is rotatable relative to the first frame so as to rotate engaged containers.

In a third aspect, the invention provides a lid engagement device comprising an actuator for positioning a lid engagement frame proximate to a lid of a container, said frame arranged to engage said lid so as to permit the actuator to move said lid relative to the container; said lid engagement device is mountable to lifting apparatus.

In a fourth aspect, the invention provides a lid locking assembly for locking a shipping container lid comprising a locking pin and locking recess; an engagement portion for receiving an applied load; a linkage for connecting the engagement portion and locking pin; wherein the assembly is arranged such that on application of the applied load the locking pin is movable from a locked position engaged with the recess and so locking the lid to the container and an unlocked position.

Accordingly, the inclusion of a lid engagement device which is mounted to the spreader allows for the removal and replacement of the lid as part of the manipulation of the container. No separate process is required prior to the loading and unloading of material to the container as the operator of the spreader can control the lid engagement device as part of the normal operation of the spreader.

The lid engagement device may be permanently fixed to the spreader so as to have the spreader and lid engagement device as an OEM construction at the time of manufacturing the spreader. Alternatively, the lid engagement device may be selectively removable from the spreader so as to fit to existing spreaders and thus improve the capability of a standard spreader.

In a further embodiment, the spreader may comprise a first and second frame with the lid engagement device mounted to the first frame and the container engageable by the second frame said first and second frames being in rotational engagement. In this embodiment the spreader may be a tipping spreader whereby the first frame remains stationery whilst the second frame rotates the container so as tip out the particular matter from the container. In this embodiment a further process step may be removed in that the unloading of the material can also be under the control and operation of the spreader operator.

It will be appreciated that the lid engagement device may be separately mountable to a range of lifting apparatus, such as a crane spreader, fork lift spreader and reach stacker spreader.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIGS. 1A to 1D are sequential isometric views of a spreader assembly according to one embodiment of the present invention;

FIGS. 2A to 2E are sequential isometric views of a tipping spreader assembly according to a further embodiment of the present invention;

FIGS. 3A to 3I are side elevation views of the tipping spreader assembly of FIGS. 2A to 2E;

FIGS. 3J and 3K are detailed views of a twist lock to casting engagement of the tipper spreader assembly of FIGS. 2A to 2E;

FIGS. 4A to 4F are sequential views of a dual tipping spreader assembly according to a further embodiment of the present invention;

FIGS. 5A and 5B are isometric views of a container with a lockable lid according to one embodiment of the present invention, and;

FIGS. 6A and 6B are detailed views of a lid locking assembly according to one embodiment of the present invention.

### DETAILED DESCRIPTION

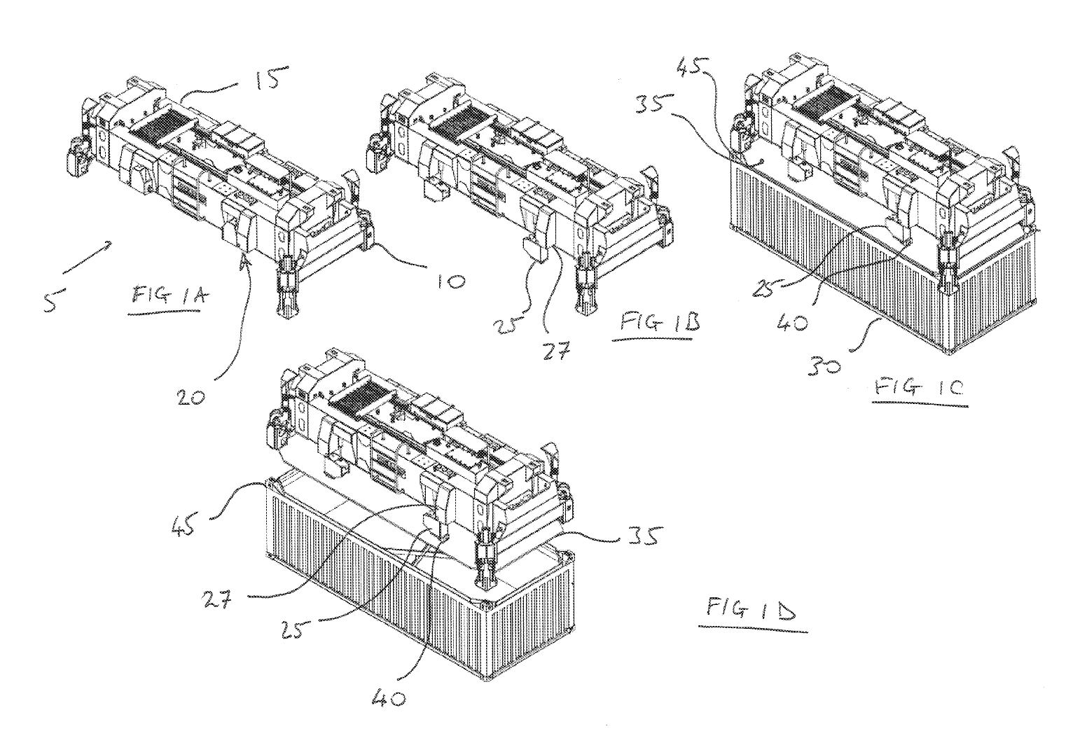

FIGS. 1A to 1D show a spreader assembly according to one embodiment of one aspect of the present invention. Here we have the spreader assembly 5 having a spreader 15 with engagement devices 10, in this case twistlock devices, for engaging a container. Further, mounted to the spreader 15 is a lid engagement device 20. The lid engagement device 20 includes four vertical actuators 27 with each actuator arranged to lift and lower a twistlock device 25. The lid engagement device 20 is located centrally on the spreader 15 so as to be within the arrangement of container twistlock devices 10. As shown in FIG. 1B, the actuators 27 lower the lid twistlock devices 25 and as seen in FIG. 1C engage with corresponding castings 40 located on a lid 35 of a container 30. In this embodiment, the operator of the spreader assembly 5 can choose to engage the container 30 through the twistlock devices 10 with the corresponding castings 45 located in the container. In the embodiment shown in FIGS. 1A to 1D, however, the operation only involves the engagement and removal of the lid 35. And so as can be seen in FIG. 1D the lid 35 having the castings 40 has been lifted from the container 30 through engagement of the lid twistlock 25. The lid is consequently lifted through lifting of the spreader by the crane. Thus, the spreader assembly 5 having a lid engagement device 20 is capable of engaging and disengaging with a container whilst at the same time being able to engage and disengage with a lid for removal from the container.

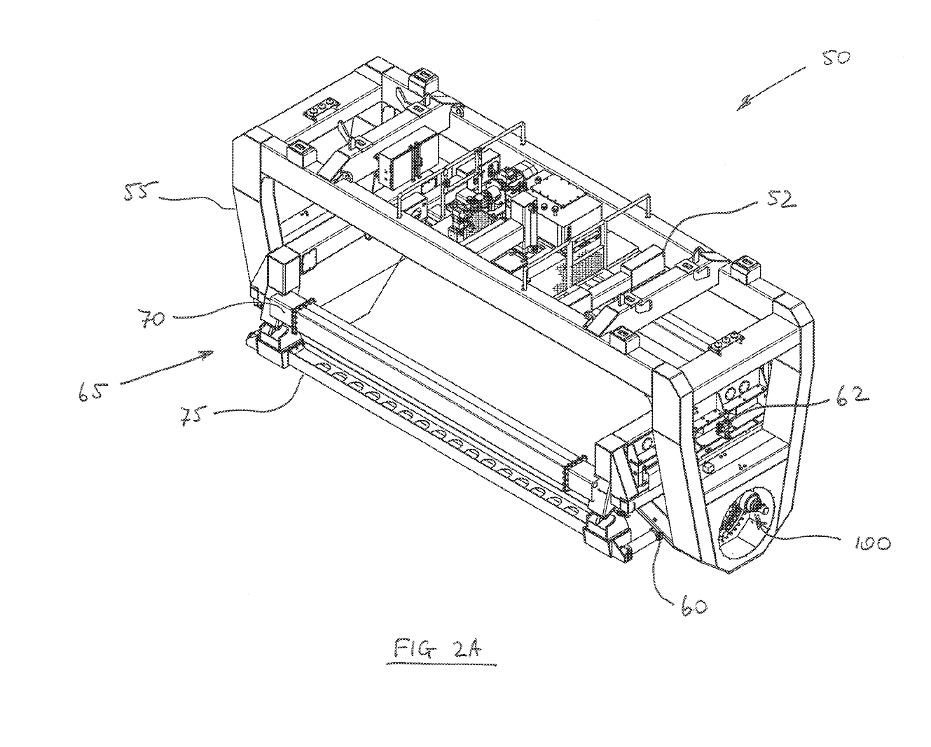

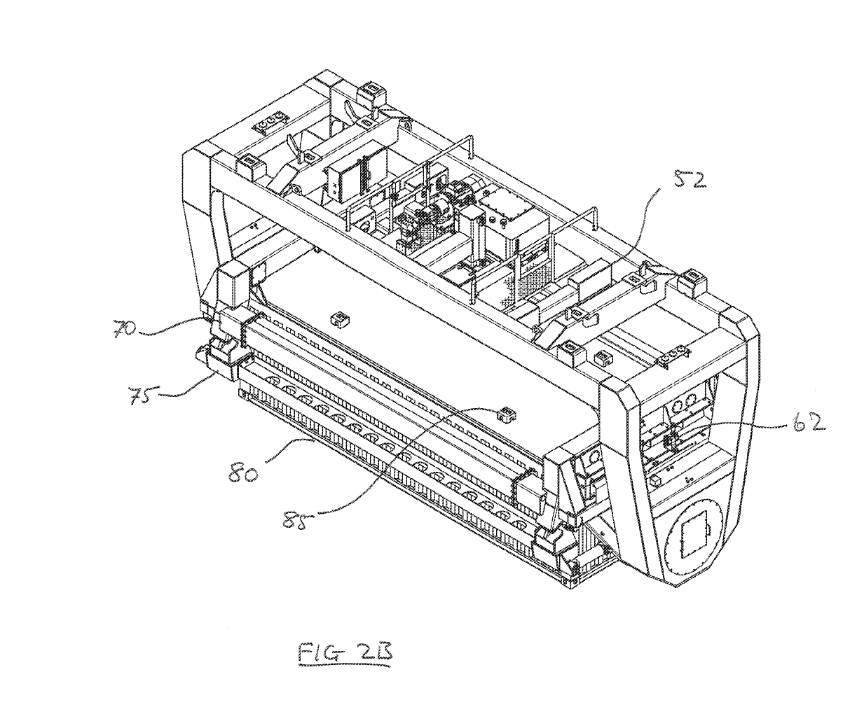

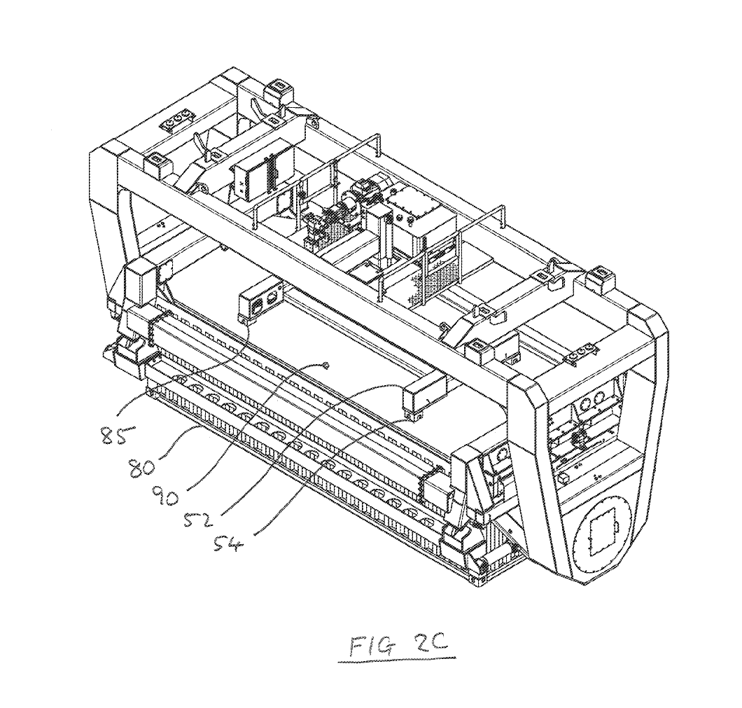

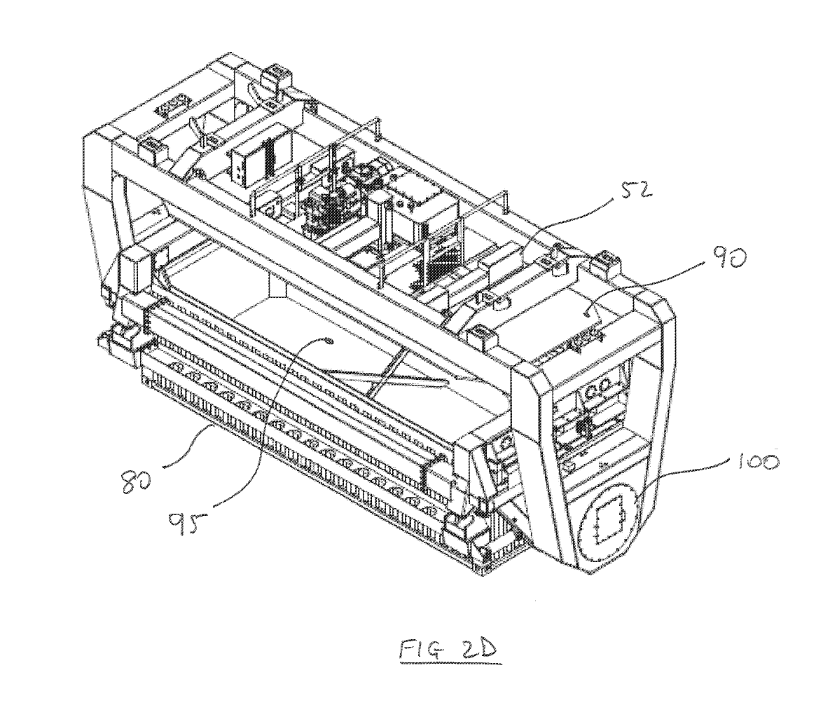

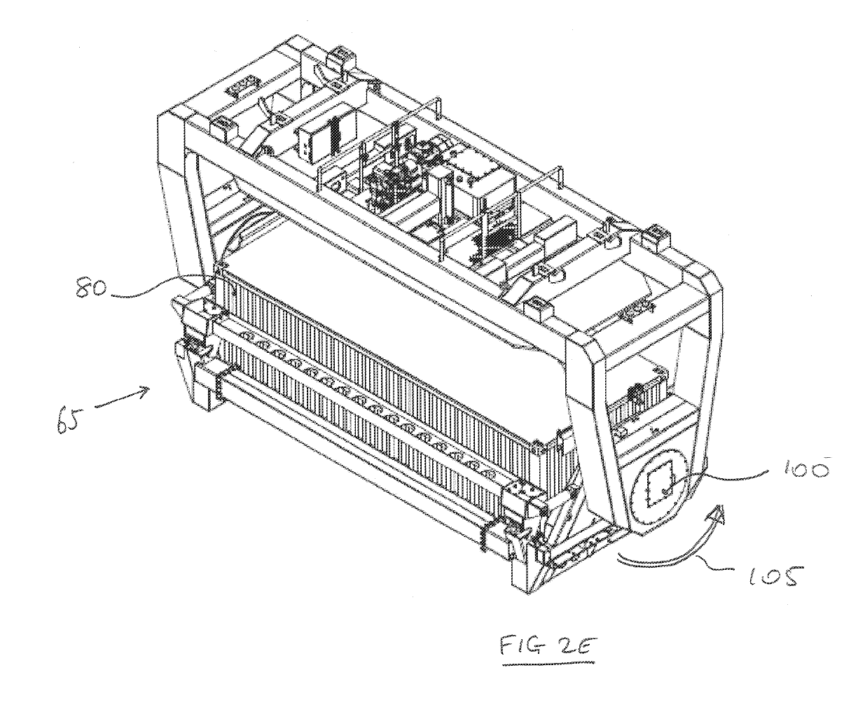

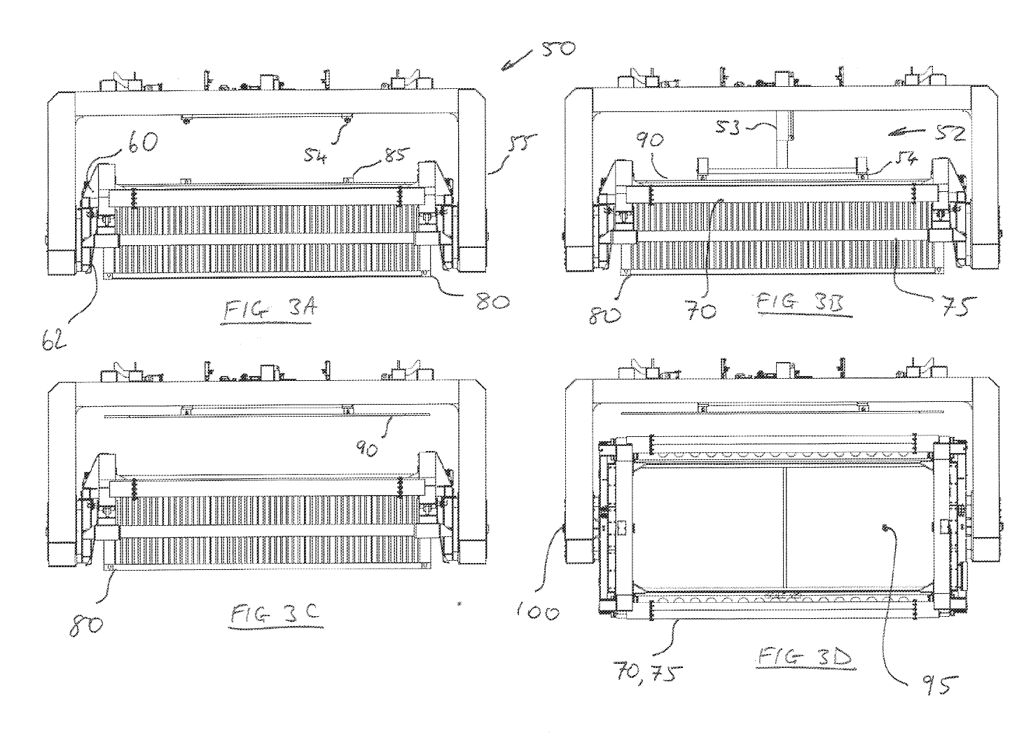

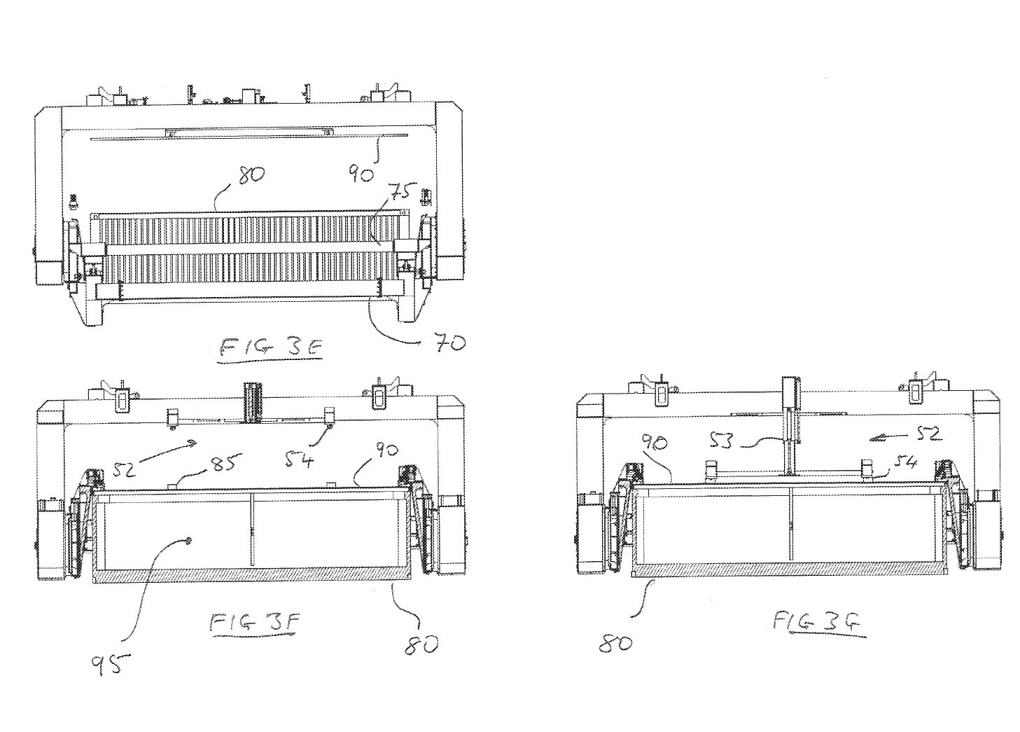

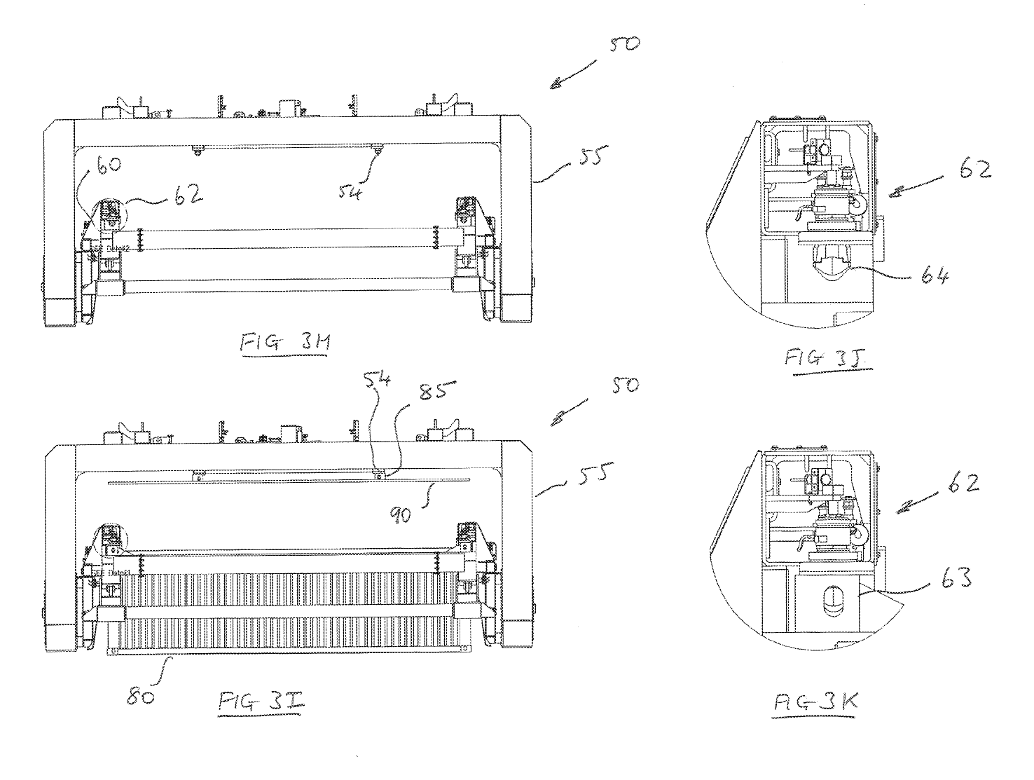

FIGS. 2A to 2E and FIGS. 3A to 3K show a further embodiment of the present invention, whereby the spreader assembly 50 comprises a first frame 55 and a second frame 60. The first and second frames 55, 60 are in rotational engagement through a rotational actuator 100. In this embodiment, the first frame 55 remains fixed in place relative to the second frame 60 with the second frame 60 being able to rotate relative to the first frame 55 on operation of the rotational actuator 100.

As shown in FIGS. 2B and 3A, the spreader assembly 50 engages a container 80. In this embodiment, however, the engagement is through the second frame 60 which has engagement portions 62 for engaging the container 80 through the normal twistlock devices. The lid engagement device 52 having an actuator 53 which lowers the twistlock devices 54 mounted to engage with twistlock castings 85 located in the lid 90 of the container 80. FIGS. 2D and 3C then show the actuator 53 retracting so as to lift the lid 90 clear from the container 80 so as to expose the containment area 95 within the container.

The rotational actuator 100 is activated so as to rotate 105 the container to empty the contents from the void 95 and thus unload the container whilst still engaged with the spreader assembly 50. Whilst this embodiment shows a full inversion of the container 80, other embodiments may have a different rotational angle as is required by the particulate matter of individual applications.

This embodiment further includes a support device 65 comprising movable 75 and fixed 70 support arms. It will be appreciated that when the container 80 is in the normal position as shown in FIG. 2B or the inverted position as shown in FIG. 2E, the twistlock devices will be subject to shear loads for which the twistlock device is not adequately designed. However, as shown in FIG. 3D, through rotation 105 the container will pass through a point when it is at 90 degrees and so having a maximum shear force applied to the twistlock device. As the twistlock device is not specifically designed to resist shear loads, the twistlock may deform and therefore become unusable, locking the container in place. To support the container as it passes from the normal position to the inverted position, the support device 65 can move the movable arm 75 to positions in support of the container 80 and thus support the full load of the container as it passes from the normal position to the inverted position. Thus, the use of the support device 65 prevents excessive shear force applied to the twistlock devices and thus preventing damage to the twistlock devices.

For clarity, FIGS. 3H and 3I have been included to more clearly show the arrangement. FIG. 3I is identical to FIG. 3C with FIG. 3H being the same spreader assembly of FIGS. 3A to 3G, with the container removed. Here the spreader assembly 50 engages the container using engagement portion 62 which include twistlock devices 64 as shown in FIG. 3J. FIG. 3K shows a detailed view of the engagement portions with the twistlock 64 inserted and engaged with casting 63 of the container 80 so as to fix the container 80 to the second frame 60 and consequently to the spreader assembly 50.

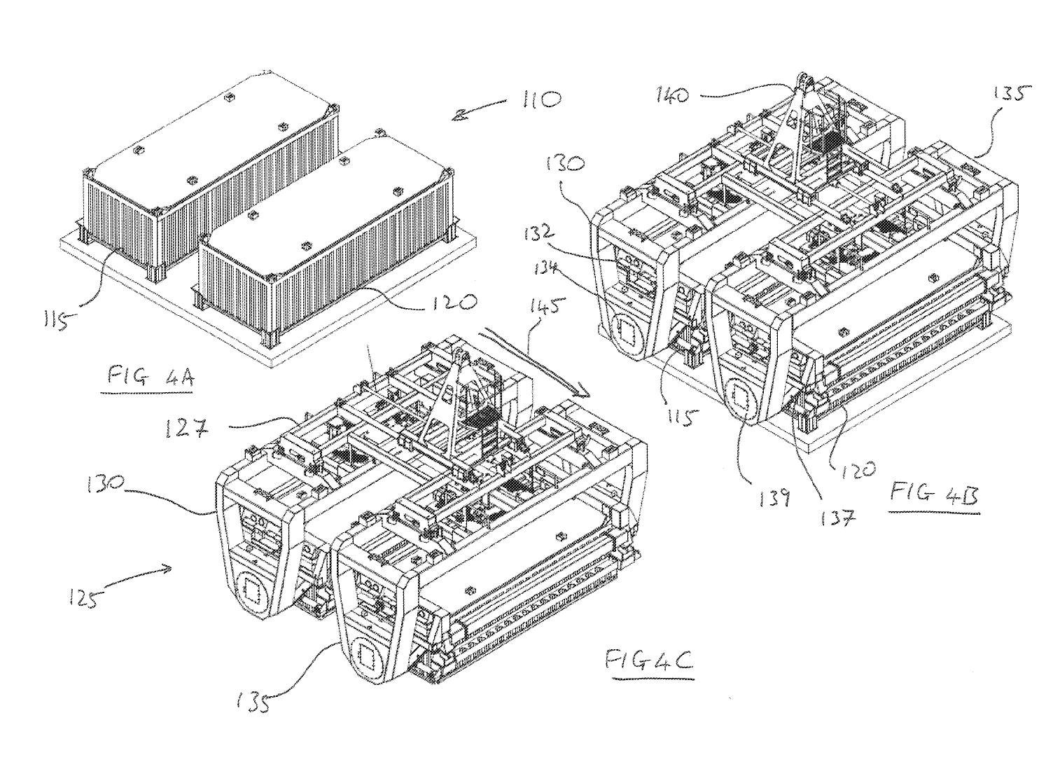

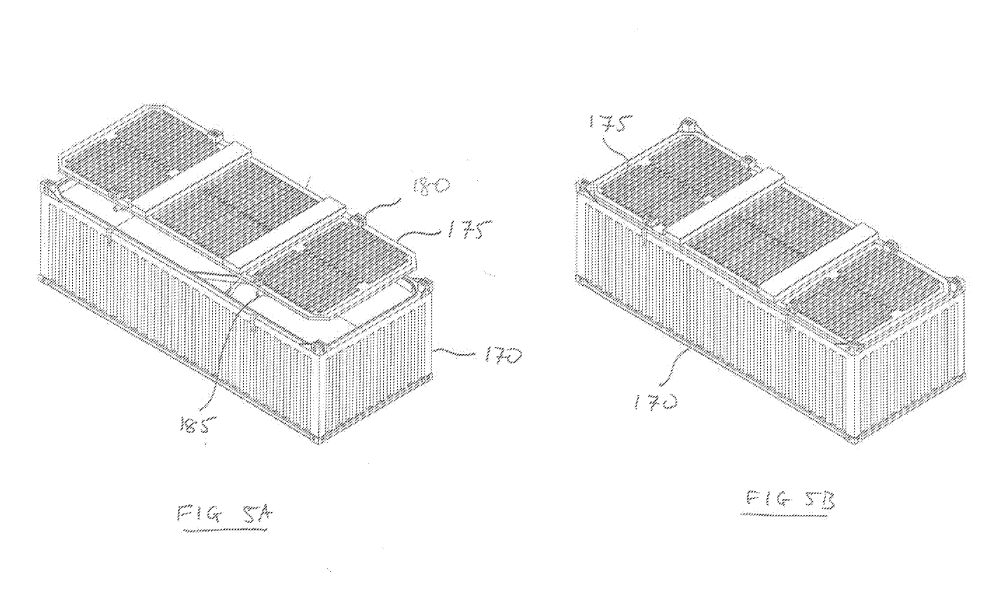

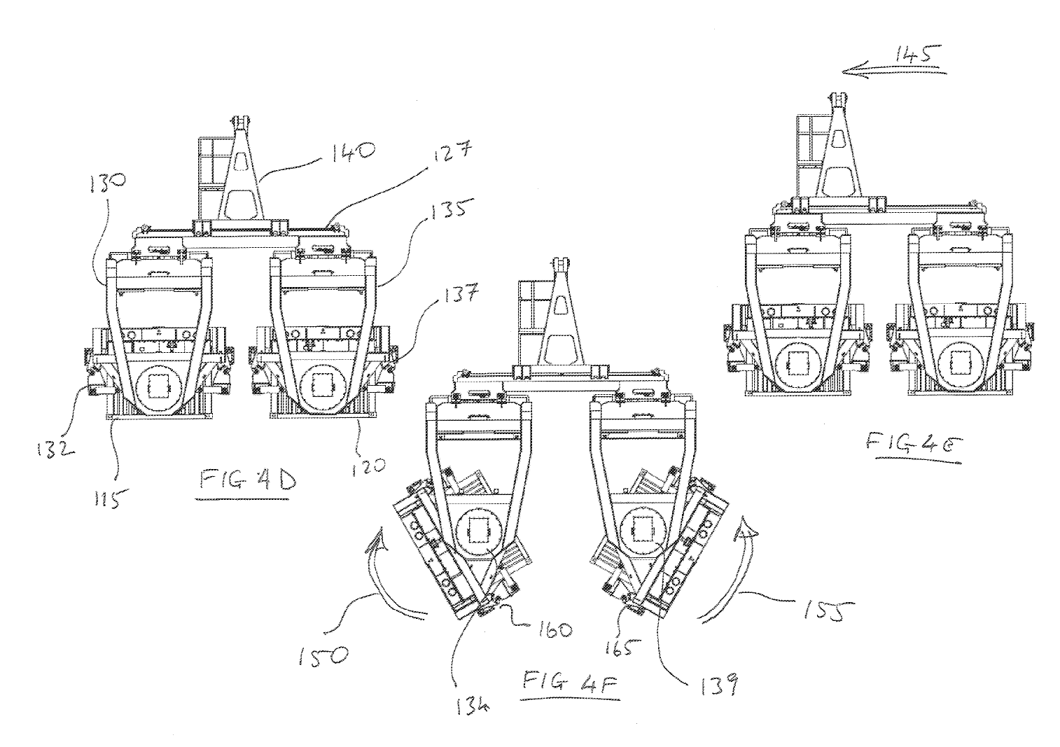

FIGS. 4A to 4F show an embodiment of a further aspect of the present invention. Here, the spreader assembly 125 comprises a head frame 127 supporting twin first frames 130, 135 which in turn are engaged with corresponding second frames 132, 137 through rotational actuators 134, 139.

The dual spreader assembly 125 is arranged to engage side by side containers 110. As seen in FIGS. 4B and 4D, the means of engagement of the individual containers 115, 120, by the second frames 132, 137, is similar to that of the embodiment of FIGS. 2A to 2E. Further, as seen in FIG. 4F, the rotational actuators 134, 139, are also arranged to rotate 150, 155, the containers 115, 120, so as to remove material from within the container once the lids of the container have been removed by corresponding lid engagement devices mounted to the first frames 130, 135.

FIG. 4F further shows corresponding support devices 160, 165, which support the containers during the rotation 150, 155, so as to avoid damage to the respective twistlock devices.

An important embodiment shown in FIGS. 4A to 4F is the incorporation of a load distribution head frame 127 having movable a support bracket 140. It will be appreciate that the containers 115, 120 may be of a different size or carry a different load. Because of the need to distribute load evenly around the spreader it is necessary to accommodate for this variation in load. It is particularly important given the tipping capability of the spreader assembly 125, as the differential in weight of the containers during the tipping process may cause instability to the spreader assembly which may be both dangerous and lead to damage of the assembly. As an adjunct to this, it is preferable to have the containers rotated 150, 155 in opposed directions, such as outwardly as shown in FIG. 4F.

Accordingly, the movable support bracket 140 on the head frame 127 is movable laterally 145 across the head frame 127 so as to accommodate a variation in the centre of gravity once the containers 115, 120, are engaged. This lateral movement 145 of the support bracket as seen in FIG. 4E can therefore accommodate substantial variation in load between the two spreaders of this spreader assembly.

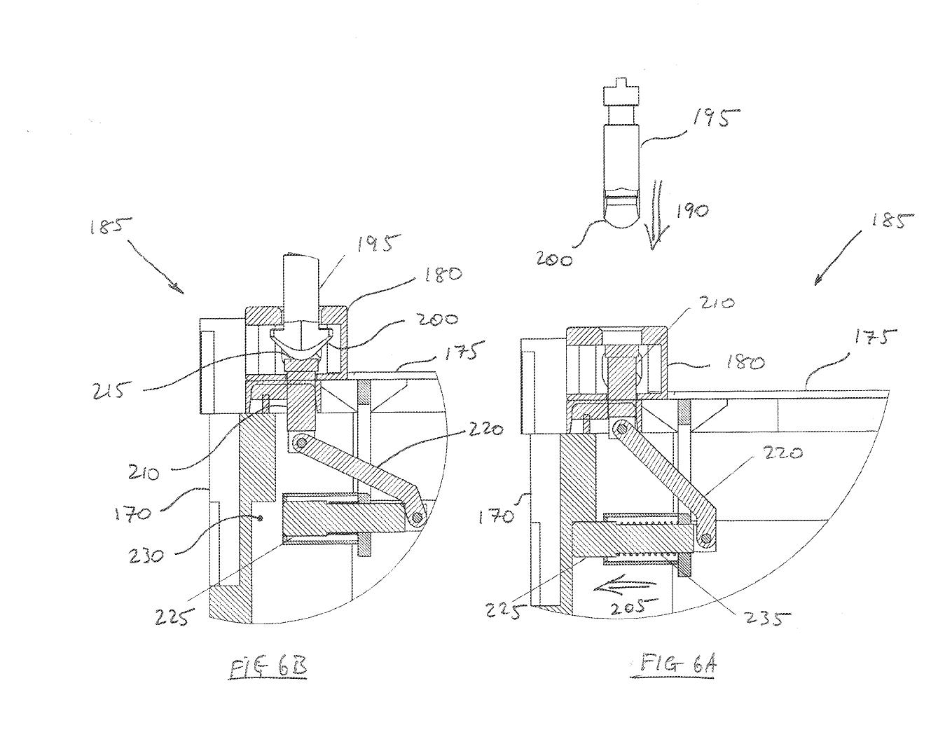

FIGS. 5A and 5B show a container 170 having a lid 175. The lid 175 includes castings 180 to receive twistlocks 195 from a lid lifting device (not shown). Mounted within and beneath the casting 180 is a lid locking assembly 185 shown in more detail in FIGS. 6A and 6B.

FIGS. 6A and 6B are sectional views showing the lid locking assembly 185. The lid locking assembly 185 has an engagement portion 210 which extends into the casting 180. On insertion 190 of the twistlock 195 into the casting 180, the locking portion 200 of the twistlock 195 contacts and applies a load to a seat 215 of the engagement portion 210 pushing the engagement portion 210 downwards. The engagement portion 210 is connected to a locking pin 225 through a linkage 220. As the engagement portion 210 is pushed downwards, the linkage retracts the locking pin 225 and so releases the locking pin from the locking recess 230. This then unlocks the lid 175 so it can be removed. As shown in FIG. 6A with the twistlock 195 retracted, the locking pin 225 is biased 205 into the locking recess 230 by a spring 235. Thus, in the normal condition without the twistlock engaging the lid locking assembly, the locking pin locks the lid in place. However, on insertion of the twistlock into the casting 180, the lid is automatically released by the lid locking assembly.

1. A spreader assembly comprising:
a spreader having container engagement devices for engaging and disengaging a container;
a lid engagement device mounted to the spreader, said lid engagement device having an actuator for positioning a lid engagement frame proximate to a lid of said container, said lid engagement frame arranged to engage said lid so as to permit the actuator to move said lid relative to the container;
a first frame to which the lid engagement device is mounted;
a second frame to which the container engagement devices are mounted, said first and second frames in rotational engagement such that the second frame is rotatable relative to the first frame; and
a support device, said support device having at least one support arm extending parallel to the longitudinal axis of the spreader and positioned proximate to a vertical wall of said container, said support device arranged to contact and support the container as the second frame rotates.

2. The spreader assembly according to claim 1, wherein said actuator is arranged to lift the lid vertically.

3. (canceled)

4. (canceled)

5. The spreader assembly according to claim 1, wherein the at least one support arm is selectively movable along an axis perpendicular to the longitudinal axis of the spreader.

6. The spreader assembly according to claim 5, wherein the support device includes two support arms.

7. The spreader assembly according to claim 5, further including a rotational actuator for rotating the second frame relative to the first frame.

8. A dual spreader assembly for engaging two containers comprising:
a head frame;
two parallel spreaders mounted to the head frame;
each spreader having a first frame through which the spreader is mounted to the head frame and a second frame arranged to engage the respective container, wherein said first and second frames are in rotational engagement such that the second frame is rotatable relative to the first frame so as to rotate engaged containers,
wherein each of said first frames includes a lid engagement device mounted thereto, each of said lid engagement devices having an actuator for positioning a lid engagement frame proximate to a lid of said respective container, said frame arranged to engage said lid so as to permit the actuator to move said lid relative to the respective container.

9. (canceled)

10. The dual spreader assembly according to claim 8, further including a support device mounted to each spreader, each of said support devices having at least one support arm extending parallel to the longitudinal axis of the spreader and positioned proximate to a vertical wall of said container, said support device arranged to contact and support the container as the second frame rotates.

11. The dual spreader assembly according to claim 8, further including a support bracket mounted to said head frame, said support bracket selectively movable perpendicular to longitudinal axes of said spreaders, said support bracket arranged to move to a position above a centre of gravity of said dual spreader assembly when in engagement with the respective containers.

12. A lid engagement device comprising:
an actuator for positioning a lid engagement frame proximate to a lid of a container, said frame arranged to engage said lid so as to permit the actuator to move said lid relative to the container, said engagement frame in rotational engagement with a second frame to which container engagement devices are mounted wherein said second frame is rotatable relative to the engagement frame;
said lid engagement device is mountable to lifting apparatus.

13. The lid engagement device according to claim 12 wherein said lifting apparatus includes a crane spreader, a fork lift spreader and a reach stacker spreader.

14. A lid locking assembly for locking a shipping container lid comprising:
a locking pin and locking recess;
an engagement portion for receiving downward applied load;
a linkage for connecting the engagement portion and locking pin;
wherein the assembly is arranged such that on application of the downward applied load the locking pin is movable from a locked position engaged with the recess and so locking the lid to the container and an unlocked position.

15. The lid locking assembly according to claim 14 wherein the engagement portion is positioned within a twistlock casting such that the downward applied load is provided by a twistlock on insertion into the casting.

16. The lid locking assembly according to claim 14, wherein the linkage is arranged to apply a horizontal load to the locking pin so as to move the locking pin horizontally into the locking recess.

17. The lid locking assembly according to claim 14, wherein the locking pin is biased toward the locked position.

18. The spreader assembly according to claim 2, wherein the at least one support arm is selectively movable along an axis perpendicular to the longitudinal axis of the spreader.

19. The spreader assembly according to claim 6, further including a rotational actuator for rotating the second frame relative to the first frame.

20. The dual spreader assembly according to claim 10, further including a support bracket mounted to said head frame, said support bracket selectively movable perpendicular to longitudinal axes of said spreaders, said support bracket arranged to move to a position above a centre of gravity of said dual spreader assembly when in engagement with the respective containers.

21. The lid locking assembly according to claim 15, wherein the linkage is arranged to apply a horizontal load to the locking pin so as to move the locking pin horizontally into the locking recess.

22. The lid locking assembly according to claim 15, wherein the locking pin is biased toward the locked position.

23. The lid locking assembly according to claim 16, wherein the locking pin is biased toward the locked position.
